(19) United States
(12) Patent Application Publication
(10) Pub. No.: US 2024/0246170 A1
(43) Pub. Date: Jul. 25, 2024

(54) SYSTEMS AND METHODS FOR MONITORING AND/OR CONTROLLING SHORT-PULSE LASER WELDING

(71) Applicant: IPG PHOTONICS CORPORATION, OXFORD, MA (US)

(72) Inventors: Dustin W. Tesselaar, Oxford, MA (US); Paul JL WEBSTER, Kingston (CA); Evan Pournejad, OXFORD, MA (US)

(73) Assignee: IPG PHOTONICS CORPORATION, OXFORD, MA (US)

(21) Appl. No.: 18/417,627

(22) Filed: Jan. 19, 2024

Related U.S. Application Data
(60) Provisional application No. 63/440,334, filed on Jan. 20, 2023.

(51) Int. Cl. B23K 26/0622; B23K 26/03; B23K 26/21

(52) U.S. Cl. CPC B23K 26/0622; B23K 26/032; B23K 26/21

(57) ABSTRACT

Systems and methods may be used to monitor and/or control a short-pulse laser welding process involving the formation of a series of heat stakes in the welded materials. The systems and methods use an imaging system, such as an ICI system, capable of obtaining measurements inside the vapor channels during formation of the heat stakes and thus provide stake measurement data representing characteristics of the stakes. The stake measurement data may be used to monitor and/or control the short-pulse laser welding process.

### CROSS-REFERENCE TO RELATED APPLICATION

The present application claims the benefit of U.S. Provisional Application Ser. No. 63/440,334, filed Jan. 20, 2023, which is fully incorporated herein by reference.

### TECHNICAL FIELD

The present disclosure relates to monitoring and/or controlling laser welding processes and more particularly, to systems and methods for monitoring and/or controlling short-pulse laser welding involving the formation of heat stakes.

### BACKGROUND INFORMATION

Lasers are often used as effective manufacturing tools for joining applications. Fiber lasers have been established as a tool of choice, not only for high power welding of thick material, but also for thin metal micro-welding applications. Short-Pulsed infrared fiber lasers with pulse widths in the nanosecond regime have shown high capability in challenging laser welding applications, such as micro-welding of thin metals (<0.5 mm thick), welding metals that are highly reflective to the 1 μm near infrared wavelength, and/or high strength welding of dissimilar metals.

These challenging welding applications may be used in many different industries, including consumer electronics, e-mobility, medical devices, energy storage, renewable energy, and aerospace/defense. Laser welding processes used in such industries often involve a high level of process control to yield a reliable and quality product. In addition, a capable in-situ monitoring system may be beneficial given the high volume nature of some products manufactured with use of short-pulse infrared fiber lasers.

Welding processes for metals that demonstrate high reflectivity in the near infrared (such as copper, aluminum, brass, silver, gold, etc.) generally use higher laser intensities to enable sufficient absorbed power and meaningful coupling for effective processing. Introducing low thickness and a dissimilar metal combination adds to the overall welding challenge and complexity of the problem. Consequently, the process window for thin dissimilar welding of reflective materials is often narrow. High intensity beams generated from short-pulse lasers at high repetition rates (e.g., in a range of 20-500 KHz) can be detrimental if the process is not carefully optimized, resulting in defects such as incomplete or over penetration, fracture-causing intermetallic compound formation, distortion, and ablation rather than effective welding. Intermetallic compounds are alloys formed by mixing two or more metallic elements. Formation of intermetallic alloying layers at the weld joint may result in brittle low-strength welds. The higher the intermetallic layer thickness, the less ductile the weld.

Short-pulsed high brightness fiber lasers can overcome the reflectivity of bright metals using high peak power while keeping the overall heat input lower as compared to a comparative wavelength continuous-wave (CW) laser. Further, by employing specific advantageous temporal pulse shapes, the high peak power of substantially single-spatial mode laser beams operated at high pulse repetition rates creates a liquid-vapor channel known as a welding “keyhole.” The formation of keyholes results in a series of spikes or stakes in this regime of welding, with the overall depth of the stakes directly relating to the total weld penetration.

Detailed characterization of stake formation and understanding the dynamics of the keyhole formed by high repetition short-pulses help to achieve a successful welding process. Existing ex-situ destructive and non-destructive testing methodologies are time consuming, incomprehensive, and unable to support the level of quality assurance needed in a high volume production environment in an affordable manner. Certain conventional imaging process monitoring systems lack the capability to fully characterize and monitor such welds.

Accordingly, there is a need for a sophisticated in-situ weld monitoring solution capable of imaging, characterizing, and processing keyhole data obtained from a short-pulse laser welding process addressing the aforementioned welding challenges.

### SUMMARY

Consistent with an aspect of the present disclosure, a system is provided for performing a short-pulse laser weld process and monitoring and/or controlling the short-pulse laser weld process. The system includes a pulsed laser source configured to generate a process beam for performing the short-pulse laser weld process at a weld site for joining at least first and second workpiece materials. The pulsed laser source is configured to generate the process beam with a pulse width less than 1000 ns and a repetition rate such that the process beam is capable of penetrating at least the first workpiece material and capable of generating a series of vapor channels extending into the second workpiece material. Each vapor channel of the series of vapor channels subsequently refills to form a stake in a series of stakes extending into the second workpiece, and a series of pulses of the process beam forms each of the vapor channels and each of the stakes.

The system also includes an imaging system configured to generate an imaging beam for reflection at the weld site, to produce an interferometry output from the reflection of the imaging beam, and to detect the interferometry output to produce measurement data representing characteristics of the weld site. The measurement data includes at least stake measurement data representing characteristics of the stakes in the series of stakes extending into the second workpiece material. A beam delivery system is coupled to the pulsed laser source and the imaging system for directing the process beam and the imaging beam to the weld site on the first workpiece. A computerized system is programmed to receive the measurement data from the imaging system and to monitor and/or control the short-pulse laser weld process based on the measurement data.

Consistent with another aspect of the present disclosure, a method is provided for performing and monitoring a short-pulse laser weld process. The method includes: generating a process beam having a pulse width less than 1000 ns; generating an imaging beam; directing the process beam and the imaging beam to a weld site on a workpiece including at least first and second workpiece materials such that the process beam generates a series of vapor channels extending into the second workpiece material, wherein each vapor channel of the series of vapor channels subsequently refills to form a stake in a series of stakes extending into the second workpiece, and wherein a series of pulses of the process beam forms each of the vapor channels and each of the stakes; producing an interferometry output from a reflection of the imaging beam from the weld site; and detecting the interferometry output to produce measurement data representing characteristics of the weld site, wherein the measurement data includes at least stake measurement data representing characteristics of the stakes in the series of stakes extending into the second workpiece material.

### BRIEF DESCRIPTION OF THE DRAWINGS

These and other features and advantages will be better understood by reading the following detailed description, taken together with the drawings wherein:

FIG. 1 is a schematic block diagram of a system for monitoring and/or controlling a short-pulse laser welding process involving stake formation, consistent with embodiments of the present disclosure.

FIG. 1A is a schematic block diagram of an inline coherent imaging (ICI) system that may be used as the imaging system in FIG. 1 for monitoring and/or controlling the short-pulse laser welding process involving stake formation, consistent with embodiments of the present disclosure.

FIG. 2 is a schematic cross-sectional view of an example of stake formation using a short-pulse laser welding process, consistent with embodiments of the present disclosure.

FIG. 3A is an image showing keyhole data (depth v. weld length) measured by an imaging system while performing a short-pulse laser welding process on stainless steel using a method, consistent with one example of the present disclosure.

FIG. 3B is an image showing a subset of the keyhole data from FIG. 3A.

FIG. 4A is an image showing keyhole data (depth v. weld length) measured by an imaging system while performing a short-pulse laser welding process on copper using a method, consistent with another example of the present disclosure.

FIG. 4B is an image showing a subset of the keyhole data from FIG. 4A.

FIG. 5 is a flow chart illustrating a method of performing and monitoring a short-pulse laser weld process, consistent with an embodiment of the present disclosure.

### DETAILED DESCRIPTION

The present disclosure involves monitoring and controlling high repetition rate short-pulsed laser welding using an imaging system, such as an inline coherent imaging (ICI) system. The dynamics of short-pulsed laser welding have not always been accurately described and may have been misunderstood. Moreover, there has been uncertainty as to whether a process involving laser pulses of nanosecond duration could be effectively observed by an imaging system whose integration time is measured in multiple microseconds. If the vapor channel were collapsing between each pulse, as previously described, it would not be possible to measure its progress/penetration into the material using such imaging systems. The example systems and methods described in the present disclosure, however, show a welding process window in which a vapor channel and melt pool is sustained between many hundreds of pulses, using imaging technology that delivers microsecond and micrometer levels of time and spatial resolution, respectively. Measurements of these dynamics, using the systems and methods described herein, have a wide range of potential for engineering, monitoring and regulating such processes, including real-time applications.

As used herein, a “heat stake” (also referred to as a “stake”) refers to a weld fusion zone that extends from a first material into a second material beneath the first material, where a series of stakes are separated (at least at the deepest ends) by non-fused material. Although a stake may be tapered to a point at the deepest end, a stake may also have other shapes or configurations that are not pointed. Although the stake extends into the second material, the stake does not necessarily extend through the second material.

As used herein, “short-pulse” refers to a pulse width of a pulsed laser that is less than 1,000 nanoseconds (ns) and a “high repetition rate” refers to a repetition rate of the pulsed laser that is greater than 10 kHz. As used herein, inline coherent imaging (ICI) refers to a process where an imaging beam is directed to a workpiece together or “inline” with a process beam for purposes of measuring characteristics of the process and/or workpiece. The term “inline” does not require the imaging and process beams to be co-axial. The imaging beam may be co-axial with the process beam or may be offset or angled relative to the process beam.

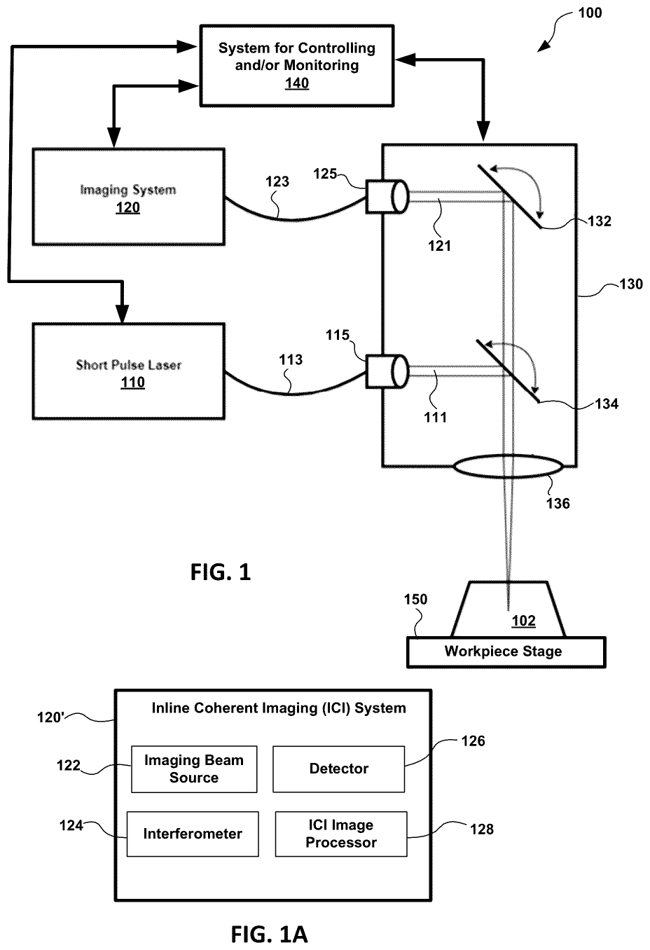

Referring to FIG. 1, a system 100 for controlling and/or monitoring a short-pulse laser welding process on a workpiece 102 is shown and described in greater detail. The system 100 generally includes a pulsed laser source 110, an imaging system 120, a beam delivery system 130, and a computerized system 140 for controlling and/or monitoring. As will be described in greater detail below, pulsed laser source 110 generates a process beam 111, the imaging system 120 generates an imaging beam 121, and the beam delivery system 130 directs the beams 111, 121 to the workpiece 102. The pulsed laser source 110 and the imaging system 120 may be coupled to the beam delivery system 130, for example, using optical fibers 113, 123 and fiber optic collimators 115, 125. Other structures and configurations for coupling an imaging system and pulsed laser source to a beam delivery system are also contemplated. The workpiece 102 includes at least two workpiece materials, such as dissimilar metals, to be welded, and the top workpiece material may be reflective and relatively thin.

The pulsed laser source 110 generates a process beam 111 for performing the short-pulse weld process at a weld site on the workpiece 102 for joining at least first and second workpiece materials. The pulsed laser source 110 may include a short-pulse fiber laser configured to generate a process beam having a wavelength in the infrared (IR) range, a pulse width in a range of 1 to 1000 ns and a high repetition rate in a range of 20 to 1000 kHz. The pulsed laser source 110 may also have a pulse width as short as 50 fs to 100 ps. As will be described in greater detail below, the pulse width and the repetition rate are set such that the process beam is capable of penetrating at least the first workpiece material (e.g., the top thin material) and capable of generating a series of vapor channels (also known and referred to as keyholes) extending into the second workpiece material, for example, when the process beam is translated across the first workpiece material. Each vapor channel of the series of vapor channels subsequently refills to form a stake in a series of stakes extending into the second workpiece. A series of pulses of the process beam thus forms each of the vapor channels and each of the stakes as the process beam is translated relative to the first workpiece material.

The imaging system 120 generates an imaging beam 121 for reflection at the weld site, produces an interferometry output from the reflection of the imaging beam and detects the interferometry output to produce measurement data representing characteristics of the weld site, for example, the depth of penetration at each point across the length of the weld. As will be described in greater detail below, the measurement data includes at least stake measurement data representing characteristics of the stakes in the series of stakes extending into the second workpiece material. Stake measurement data may include, without limitation, statistical distribution of a number of stakes formed, frequency of stakes formed, and depth of stakes formed. Other measurement data may include, without limitation, surface signal data representing reflection of the imaging beam from a surface of a workpiece. Although the imaging system 120 is an inline coherent imaging (ICI) system in embodiments described herein, one skilled in the art would understand that an optical coherence tomography (OCT) system may also be used.

FIG. 1A shows one embodiment of an inline coherent imaging (ICI) system 120′ that may be used as the imaging system 120 in FIG. 1. In this embodiment, the ICI system 120′ includes an imaging beam source 122, such as a semi coherent light source, for generating the imaging beam 121. The ICI system 120′ also includes an interferometer 124, such as a Michelson interferometer, for producing the interferometry output from the reflected imaging beam reflected from the workpiece 102. The interferometry output may be based on at least one optical path length to the workpiece and at least one other optical path length (a reference path). The ICI system 120′ further includes a detector 126, such as a spectrometer and camera, for detecting the interferometry output to produce interferogram data and an ICI image processor 128 to process the interferogram data and produce the measurement data. Examples of ICI systems and methods for monitoring keyhole welding processes are described in greater detail, for example, in U.S. Pat. Nos. 11,426,816 and 11,327,011 and U.S. patent Application Publication Nos. 2020/0198050 and 2021/0323086, which are commonly-owned and fully incorporated herein by reference.

The beam delivery system 130 coupled to the pulsed laser source 110 and the imaging system 120 delivers the imaging beam 121 together with the process beam 111 to the weld site on the workpiece 102. The beam delivery system 130 may include scanning optics, such as deflection elements (e.g., mirrors 132, 134), that move the process beam 111 to provide substantially continuous translation on the workpiece 102 and move the imaging beam 121 together with the process beam 111. The translation of the process beam 111 relative to the workpiece 102 may be at a speed in the range of about 10 mm/s to 2000 mm/s. In other embodiments, the workpiece 102 may be moved (e.g., on a workpiece stage 150) to achieve translation of the process beam 111 and the imaging beam 121 across the workpiece 102. Although the process beam 111 is continuously translated across the workpiece 102 in embodiments described herein, the systems and methods for monitoring short-pulse laser welding, according to the present disclosure, may also be used to monitor and/or control welding methods where the process beam 111 is moved discontinuously (e.g., stop and shoot).

In the illustrated embodiment, the beam delivery system 130 is a welding head including at least a first mirror 132 for deflecting the imaging beam 121 and at least a second mirror 134 (e.g., a dichroic mirror) for deflecting the process beam 111 and passing the imaging beam 121 together with the process beam 111 (i.e., a dichroic beam combiner). The deflection elements (e.g., mirrors 132, 134) may be separately moveable or adjustable (e.g., using motors to rotate the mirrors 132, 134) to provide alignment of the imaging beam 121 and the process beam 111 directed towards the workpiece 102. The beam delivery system 130 also includes an objective lens or focusing objective 136 that focuses the beams on the workpiece 102. Other embodiments of the beam delivery system 130 may include a deflection element (e.g., a mirror) for deflecting both the process beam and the imaging beam together.

The computerized system 140 for monitoring and/or controlling may be connected to the pulsed laser source 110, to the imaging system 120, to the beam delivery system 130, and to the workpiece stage 150. The computerized system 140 may be programmed to control laser parameters in the pulsed laser source 110, programmed to receive the measurement data from the imaging system 120, and programmed to control movement of the process beam 111 and/or imaging beam 121 relative to the workpiece 102 (e.g., by controlling movement of the mirrors 132, 134 and/or the workpiece stage 150). The computerized system 140 may include, for example, hardware (e.g., a general-purpose computer or microcontroller) and software known for use with imaging systems, such as ICI systems, and for controlling lasers and scanners. The computerized system 140 may include a user interface (e.g., a keyboard and display or a touchscreen) to provide user input to the computerized system 140 and to provide output to the user.

In some embodiments, the computerized system 140 may include separate controllers for each of the subsystems (e.g., the pulsed laser source 110, the imaging system 120, the beam delivery system 130, and the workpiece stage 150) and a process master controller to control and coordinate all of the subsystems and associated controllers. In some cases, one of the subsystem controllers may act as the process master controller. The computerized system 140 may also include known data storage media for storing measurement data, such as the stake measurement data, for use in monitoring and/or controlling laser welding processes.

In one embodiment, the pulsed laser source may include an Ytterbium nanosecond pulse fiber laser, such as an IPG YLPN-1-30x240-300-R laser available from IPG Photonics, the beam delivery system 130 may include a scanner head, such as an IPG Mid-Power scanner available from IPG Photonics, and the imaging system 120 may include an inline coherent imaging (ICI) system such as an IPG LDD-700 inline welding process monitor available from IPG Photonics. This system may also be used together with various clamping/fixturing, air knives, shield gas and other accessories known to those skilled in the art of welding, especially laser welding, to join one or more workpieces together by way of pulsed laser welding.

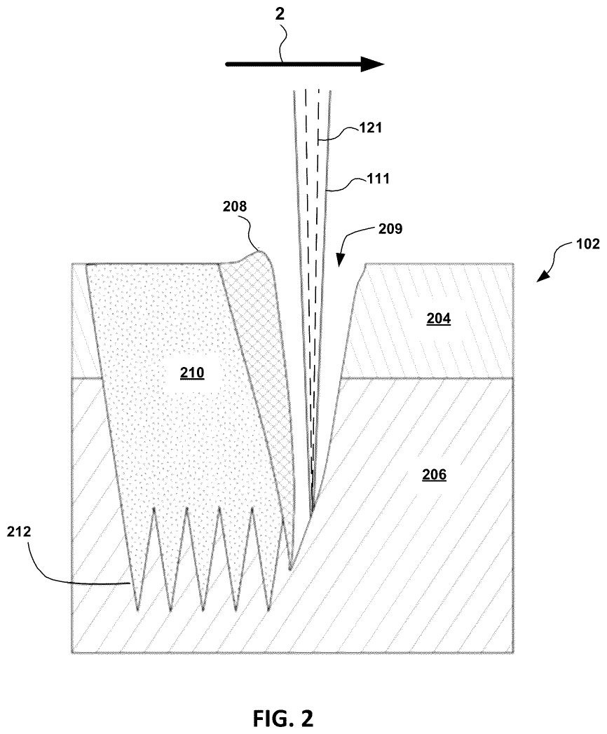

Referring to FIG. 2, the formation of stakes in the materials being welded is described in greater detail. As shown, the workpiece 102 includes at least a first workpiece material 204 being welded to a second workpiece material 206 underneath or below the first workpiece material 204. The process beam 111 is directed to the first workpiece material 204 and is continuously translated relative to the workpiece 102 in the direction of arrow 2 while being pulsed, as described above. The parameters of the process beam 111, such as power, repetition rate, pulse duration, and speed, may be determined based on the workpiece materials 204, 206 being welded.

In one embodiment, the workpiece materials 204 are metallic, arranged in an overlap configuration, and the top sheet or material 204 is thin enough that the laser pulses can fully penetrate in order to deliver laser energy onto or into the bottom sheet or material 206. The laser and motion parameters are set such that the welding process generates a melt pool 208 (i.e., molten metal) and a vapor channel 209, which serves to trap laser pulses (increasing energy coupling) and allow the laser energy to penetrate deeper into the material stack. When the scanner (or such other device that causes relative motion between the laser aiming point and the workpiece) causes the process beam 111 to be continuously translated across the workpiece, the vapor channel 209 may not be continuously supported by, nor one-to-one with, the individual laser pulses. Instead, the weld 210 (i.e., the fusion zone) that is formed is characterized by a series of spikes or stakes 212 resulting from the vapor channels 209, each of which are opened by multiple pulses and subsequently collapse.

As a vapor channel 209 is opened and material is fed relative to the process beam 111, successive pulses are misaligned to the center of the channel 209, but only by a small amount, so most of their energy is still deposited and trapped inside the channel 209, causing it to deepen and widen. However, the rate that the channel 209 widens cannot keep pace with the translation of the process beam 111, and eventually the absorbed energy portion of each pulse begins to drop as more of it misses the mouth of the vapor channel 209. At this point, the vapor channel 209 begins to collapse, and the surrounding melt 208 begins to refill the channel 209 to form the weld 210. Shortly thereafter, a new vapor channel begins to open, and the process repeats itself. The formation of a series of vapor channels 209 by the continuous translation of the process beam 211 relative to the workpiece 102 thus forms a series of heat stakes, where each of the vapor channels 209 and heat stakes 212 may be formed by multiple pulses of the process laser 111.

The workpiece materials 204, 206 may be dissimilar metals and at least the first workpiece material 204 may be a metal that is reflective to infrared wavelengths. The first workpiece material 204 may also be relatively thin (e.g., less than 0.5 mm) and capable of being penetrated by the process beam 111. Although only two workpiece materials 204, 206 are shown, the systems and methods described herein may also be used to weld more than two workpiece materials (e.g., multiple layers of materials).

During a short-pulsed laser welding process with stake formation, for example, as shown in FIG. 2, the imaging system 120, such as the ICI imaging system 120′ shown in FIG. 1A, may be used to measure dynamics of the process by directing the imaging beam 121 with the process beam 111 into the vapor channels 209. Although shown in FIG. 2, the imaging beam 121 is not necessarily axially aligned with the process beam 111. The imaging beam 121 may be reflected from inside the vapor channels 209 back to the ICI system 120′ where the interferometer 124 produces an interferometry output from the reflected imaging beam, for example, based on the optical path length to the to the workpiece 102 and at least one other optical path length (e.g., a reference path).

The interferometry output from the interferometer 124 may then be detected by the detector 126 and processed by the ICI image processor 128 to produce measurement data, which may include measurement signals representing keyhole data measured during the welding process. The intensity or brightness of the measurement signals may be indicative of various features measured by the reflected imaging beam such as a surface of the workpiece or bottom of a keyhole. As will be described in greater detail below, the measurement data produced from a short-pulsed laser welding process with stake formation also represents characteristics of the stakes 212 formed by the process (i.e., stake measurement data).

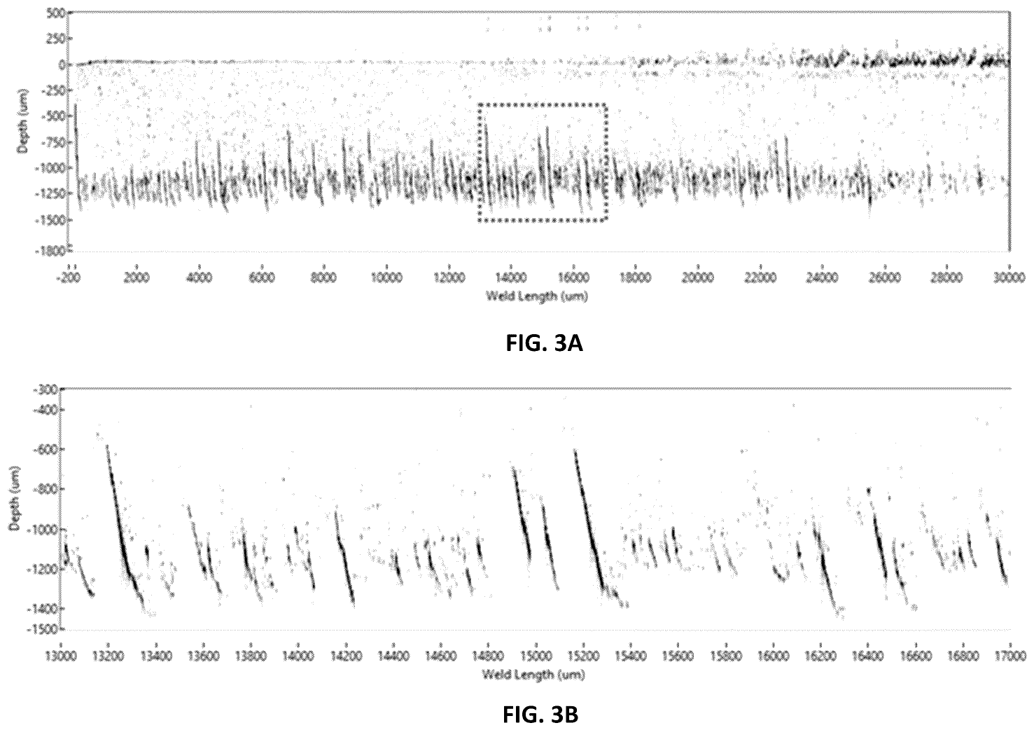

FIGS. 3A and 3B show images of measurement signals representing keyhole data measured during welding of a stainless steel workpiece material. In this example, the system included an IPG YPLN-1-30x240-300-R laser with an IPG Mid Power scanner providing beam delivery to perform the welding and an IPG LDD-700 inline welding process monitor to obtain the measurement data. In this example, the laser performed the welding on the stainless steel using an average power of 300 W, a repetition rate of 300 kHz, a pulse duration of 120 ns, a speed of 100 mm/s and over a length of 30 mm. FIG. 3A shows the measured depth over the weld length and FIG. 3B shows a subset of the data from within the dashed square in FIG. 3A. The strong descending lines in FIG. 3B indicate stake evolution.

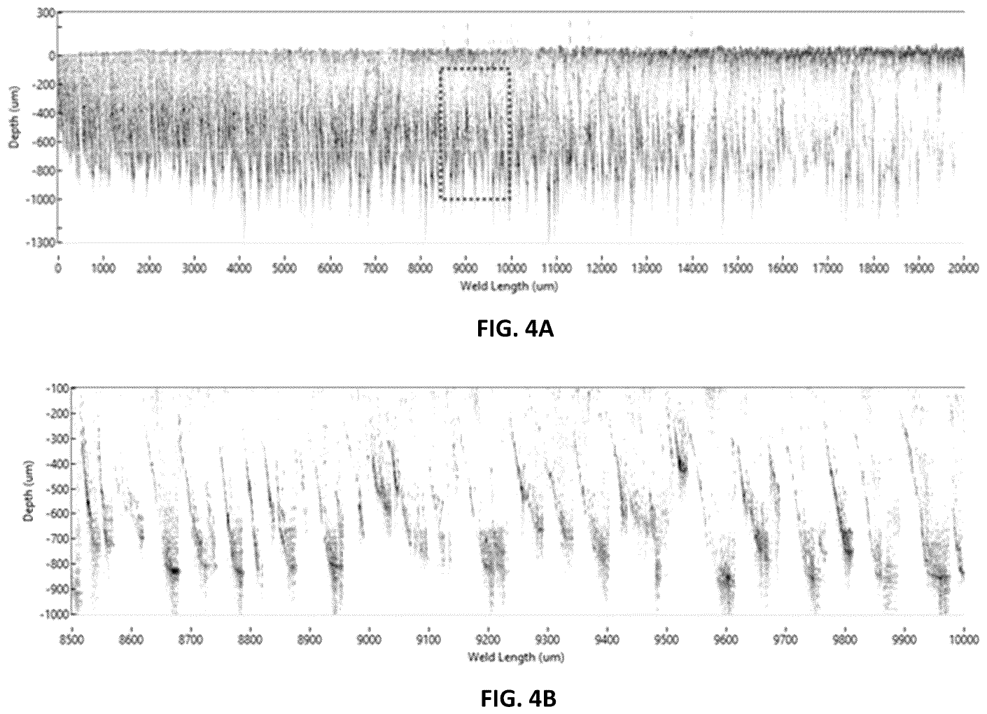

FIGS. 4A and 4B show images of measurement signals representing keyhole data measured during welding of a copper workpiece material. In this example, the system included an IPG YPLN-1-30x240-300-R laser with an IPG Mid Power scanner providing beam delivery to perform the welding and an IPG LDD-700 inline welding process monitor to obtain the measurement data. In this example, the laser performed the welding on the copper using an average power of 300 W, a repetition rate of 300 kHz, a pulse duration of 120 ns, a speed of 100 mm/s and over a length of 20 mm. FIG. 4A shows the measured depth over the weld length and FIG. 4B shows a subset of the data from within the dashed square in FIG. 4A. The regions of broad vertical measurement signal in FIG. 4B indicate a high degree of multiple internal reflections inside the stake as it is being formed. As shown by the broad vertical distribution of the measurement signal in FIG. 4B, the ICI image processor may be used to detect the presence of multiple scattering events and determine the true depth by finding the brightest peak of the distribution or otherwise fitting/convolving a statistical distribution model to the data distribution.

The measurement data produced by the imaging system 120, 120′ (e.g., the ICI image processor 128) may be further processed by the computerized system 140 to monitor and/or control the short-pulsed laser welding process and the stake formation. The computerized system 140 may be used to monitor a process by outputting (e.g., display) the measurement data generated for the laser welding process data or by outputting monitoring information generated by further processing the measurement data. The computerized system 140 may be used to control a process by processing the measurement data and determining control signals to be provided to the laser 110 to control laser parameters, to the beam delivery system 130 (e.g., to the motors rotating mirrors 132, 134) to control beam delivery, and/or to the workpiece stage 150 to control movement of the workpiece 102.

In some embodiments, the measurement data representing reflection of the imaging beam from a surface of the workpiece (i.e., a surface measurement signal) may be used to control and/or monitor the process. FIGS. 3A and 4A show the effect of uncorrected chromatic and/or other optical aberrations gradually misaligning the imaging beam from the center of the keyhole locations during a short-pulsed laser welding process with stake formation. This is most evident by the surface measurement signal at the 0 μm indicated depth, which is gradually enhanced as the process moves from about the 8000 μm indicated position in FIG. 3A and from about the 3000 μm indicated position FIG. 4A. In some embodiments, these aberrations may be corrected by way of a previous calibration and a subsequent adjustment of the imaging beam deflection as the process beam is moved around the scan field. Such deflection adjustment may be effected by the same deflection elements (e.g., mirrors) that align the imaging beam. Examples of static and dynamic calibration for coherence imaging measurement systems are described in greater detail in U.S. Published Patent Application No. 2021/0323086, which is commonly-owned and incorporated herein by reference.

According to one example of controlling the process using the measurement data, alignment of the process beam and the imaging beam may be optimized by minimizing the strength of the surface measurement signal representing reflection of the image beam from a surface of the workpiece. According to one example of monitoring the process using the measurement data, the presence of the surface measurement signal or strength of the surface measurement signal may be used to monitor the process health and/or a focus condition by comparing the intensity of the surface measurement signal to a reference level.

According to a further example, the focal spot size of the imaging beam may be selected to produce a surface measurement signal that is sufficient for use as a surface reference and/or to monitor the process health/focus condition as previously described. The focal spot size of the imaging beam may be enlarged, for example, to simultaneously or dynamically cover both the top surface and keyhole bottom, as described in U.S. Pat. No. 11,426,816, which is incorporated herein by reference and commonly-owned.

In other embodiments, measurement data representing stake formation in the workpiece (i.e., stake measurement data) may be used to control and/or monitor the process. The stake measurement data may include, for example, the statistical distribution of the number of stakes formed, the frequency of stakes formed and/or the depth of stakes formed. The computerized system 140 may store the stake measurement data for one or more processes in a storage medium. The computerized system 140 may then compare the stored and aggregated stake measurement data to the stake measurement data generated for subsequent processes using statistical comparison techniques known to those of ordinary skill in the art.

According to one example of monitoring the process using stake measurement data, the shape of a histogram plotting a number of stakes vs. depth from a reference process may be compared to a process under question using the width, centroid location and/or area of the histogram to determine if the process under question conforms to the reference process. The computerized system 140 may perform this comparison and may communicate the results of this comparison as an annunciation to the user or as a signal to other automation equipment that a conforming or nonconforming weld has been detected. In the electric mobility market, for example, this knowledge may be used to demand additional welding or rework to the workpiece to ensure that it will function properly in service.

According to one example of controlling the process using stake measurement data, the stake measurement data may be used to provide stabilization of process depth. Obtaining the stake measurement data may include directly measuring the frequency of stake formation. From data gathered in FIGS. 3A and 4A, for example, the stake formation frequency occurs at a different rate than the pulse repetition rate. In these examples, the observed stake formation frequency is measured to be between 2-3 orders of magnitude longer than the pulse repetition rate generated by the short-pulse laser used in the process. In one embodiment, the computerized system 140 may use the measured stake formation frequency to define an external modulation signal with which to gate laser emission by the short pulse laser 110. In this embodiment, the gate frequency may be less than or equal to the stake formation frequency, and the formation of individual stakes may be intentionally halted with the intention of minimizing the variation in stake depths across a weld. In another embodiment, the computerized system 140 may use the stake measurement data to optimize the duty cycle and frequency of the laser gate with the goal of weld stake depth stabilization.

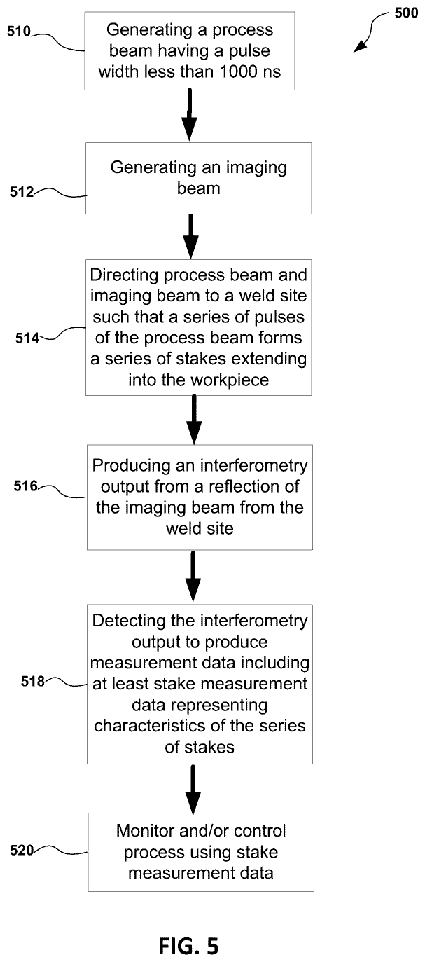

Referring to FIG. 5, one example of a method 500 of performing and monitoring a short-pulse laser weld process is illustrated and described. A process beam is generated 510 having a pulse width less than 1000 ns, for example, using the short pulse laser 110 described above and an imaging beam is generated 512, for example, using the imaging beam source 122 in the ICI system 120′ described above. The process beam may also have a high repetition rate in a range of 20 to 1000 kHz. The imaging beam may be aligned coaxially with the process beam or may be offset or angled relative to the process beam.

The process beam and the imaging beam are directed 514 to a weld site on a workpiece including at least first and second workpiece materials, for example, using the beam delivery system 130 described above, such that a series of pulses of the process beam forms a series of stakes extending into the workpiece. In particular, the process beam generates a series of vapor channels extending into the second workpiece material, each vapor channel of the series of vapor channels subsequently refills to form a stake in a series of stakes extending into the second workpiece, and a series of pulses of the process beam forms each of the vapor channels and each of the stakes. Directing the process beam and the imaging beam may include translating the process beam and the imaging beam across the workpiece, for example, at a speed in a range of 10 mm/s to 2000 mm/s, such that the process beam forms each of the vapor channels and each of the stakes as the process beam is translated.

An interferometry output is produced 516 from a reflection of the imaging beam from the weld site, for example, using the interferometer 124 in the ICI system 120′ described above. The interferometry output is then detected 518 to produce measurement data representing characteristics of the weld site, for example, using the detector 126 and the ICI image processor 128 in the ICI system 120′ described above. The measurement data includes at least stake measurement data representing characteristics of the stakes in the series of stakes extending into the second workpiece material. The stake measurement data may include, for example, statistical distribution of a number of stakes formed, frequency of stakes formed, and depth of stakes formed.

The process may then be monitored and/or controlled 520 using the stake measurement data. The process may be monitored using the stake measurement data, for example, by comparing with previously stored stake measurement data during a reference process, as described above. The process may be controlled using the stake measurement data, for example, by controlling a duty cycle and frequency of the process beam in response to a frequency of stakes formed, as described above.

Accordingly, systems and methods, consistent with embodiments of the present disclosure, may be used to monitor and/or control a short-pulse laser welding process involving the formation of a series of heat stakes in the welded materials. The systems and methods use an imaging system, such as an ICI system, capable of obtaining measurements inside the vapor channels during formation of the heat stakes and thus provide stake measurement data representing characteristics of the stakes. The stake measurement data may be used to monitor and/or control the short-pulse laser welding process.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein.

Modifications and substitutions by one of ordinary skill in the art are considered to be within the scope of the present invention, which is not to be limited except by the following claims.

What is claimed is:

1. A system for performing a short-pulse laser weld process and monitoring and/or controlling the short-pulse laser weld process, the system comprising:
a pulsed laser source configured to generate a process beam for performing the short-pulse laser weld process at a weld site for joining at least first and second workpiece materials, wherein the pulsed laser source is configured to generate the process beam with a pulse width and a repetition rate such that the process beam is capable of penetrating at least the first workpiece material and capable of generating a series of vapor channels extending into the second workpiece material, wherein each vapor channel of the series of vapor channels subsequently refills to form a stake in a series of stakes extending into the second workpiece, and wherein a series of pulses of the process beam forms each of the vapor channels and each of the stakes, and wherein the pulse width is less than 1000 ns;
an imaging system configured to generate an imaging beam for reflection at the weld site, to produce an interferometry output from the reflection of the imaging beam, and to detect the interferometry output to produce measurement data representing characteristics of the weld site, wherein the measurement data includes at least stake measurement data representing characteristics of the stakes in the series of stakes extending into the second workpiece material;
a beam delivery system coupled to the pulsed laser source and the imaging system for directing the process beam and the imaging beam to the weld site on the first workpiece; and
a computerized system programmed to receive the measurement data from the imaging system and to monitor and/or control the short-pulse laser weld process based on the measurement data.

2. The system of claim 1, wherein the repetition rate is greater than 10 kHz.

3. The system of claim 1, wherein the imaging system is an inline coherent imaging (ICI) system configured to produce the imaging beam in line with the process beam.

4. The system of claim 1, wherein the pulsed laser source is a nanosecond infrared fiber laser.

5. The system of claim 1, wherein the beam delivery system is configured to continuously translate the process beam across the first workpiece material at a speed in a range of 10 mm/s to 2000 mm/s.

6. The system of claim 1, wherein the beam delivery system includes a scanner configured to deflect and scan the process beam and the imaging beam across the first workpiece material.

7. The system of claim 1, wherein the beam delivery system includes a first mirror for deflecting the imaging beam and a second mirror for deflecting the process beam, wherein the second mirror is a dichroic mirror.

8. The system of claim 1, wherein the beam delivery system includes adjustable deflection elements configured to scan both the process beam and the imaging beam together and configured to scan the imaging beam relative to the process beam for adjusting alignment of the imaging beam relative to the process beam.

9. The system of claim 1, wherein the measurement data includes surface measurement signal data representing a reflection of the imaging beam from a surface of the first workpiece material.

10. The system of claim 9, wherein the computerized system is configured to monitor the short-pulse laser weld process using the surface measurement signal data.

11. The system of claim 9, wherein the computerized system is configured to control the short-pulse laser weld process by adjusting alignment of the imaging beam relative to the process beam in response to the surface measurement signal data.

12. The system of claim 9, wherein the computerized system is configured to control the short-pulse laser weld process by selecting a focal spot size of the process beam based on the surface measurement signal data.

13. The system of claim 1, wherein the computerized system is configured to compare the stake measurement data with previously stored stake measurement data representing characteristics of stakes formed during a reference process, and based on the comparison, to determine if the short-pulse laser weld process conforms to the reference process.

14. The system of claim 13, wherein the stake measurement data represents at least one stake characteristic selected from a group consisting of statistical distribution of a number of stakes formed, frequency of stakes formed, and depth of stakes formed.

15. The system of claim 1, wherein the stake measurement data represents at least one stake characteristic selected from a group consisting of statistical distribution of a number of stakes formed, frequency of stakes formed, and depth of stakes formed.

16. The system of claim 1, wherein the stake measurement data represents at least a frequency of stakes formed, and wherein the computerized system is configured to control a duty cycle and frequency of the process beam in response to the frequency of stakes formed.

17. A method of performing and monitoring a short-pulse laser weld process, the method comprising:
generating a process beam having a pulse width less than 1000 ns;
generating an imaging beam;
directing the process beam and the imaging beam to a weld site on a workpiece including at least first and second workpiece materials such that the process beam generates a series of vapor channels extending into the second workpiece material, wherein each vapor channel of the series of vapor channels subsequently refills to form a stake in a series of stakes extending into the second workpiece, and wherein a series of pulses of the process beam forms each of the vapor channels and each of the stakes;
producing an interferometry output from a reflection of the imaging beam from the weld site; and
detecting the interferometry output to produce measurement data representing characteristics of the weld site, wherein the measurement data includes at least stake measurement data representing characteristics of the stakes in the series of stakes extending into the second workpiece material.

18. The method of claim 17, wherein the process beam is generated with a repetition rate greater than 10 kHz.

19. The method of claim 17, wherein the process beam is generated with a repetition rate in a range of 20 to 1000 kHz.

20. The method of claim 17, wherein the process beam is generated with a pulse width in a range of 1 to 1000 ns.

21. The method of claim 17, wherein directing the process beam and the imaging beam include translating the process beam and the imaging beam across the first workpiece material such that the process beam forms each of the vapor channels and each of the stakes as the process beam is translated.

22. The method of claim 21, wherein the process beam is translated across the first workpiece material at a speed in a range of 10 mm/s to 2000 mm/s.

23. The method of claim 21, wherein translating the process beam and the imaging beam across the first workpiece material includes scanning the process beam and the imaging beam across the first workpiece material.

24. The method of claim 21, wherein translating the process beam and the imaging beam across the first workpiece material includes moving the workpiece relative to the process beam and the imaging beam.

25. The method of claim 17, further comprising monitoring the short-pulse laser weld process using the measurement data.

26. The method of claim 25, wherein the measurement data includes surface measurement signal data, and wherein the short-pulse laser weld process is monitored using the surface measurement signal data.

27. The method of claim 17, further comprising controlling the short-pulse laser weld process based on the measurement data.

28. The method of claim 27, wherein the measurement data includes surface measurement signal data, and wherein the short-pulse laser weld process is controlled by adjusting alignment of the imaging beam relative to the process beam using the surface measurement signal data.

29. The method of claim 27, wherein the measurement data includes surface measurement signal data, and wherein the short-pulse laser weld process is controlled by selecting a focal spot size of the process beam based on the surface measurement signal data.

30. The method of claim 17, further comprising comparing the stake measurement data with previously stored stake measurement data representing characteristics of stakes formed during a reference process, and based on the comparison, determining if the short-pulse laser weld process conforms to the reference process.

31. The method of claim 30, wherein the stake measurement data represents at least one stake characteristic selected from a group consisting of statistical distribution of a number of stakes formed, frequency of stakes formed, and depth of stakes formed.

32. The method of claim 17, wherein the stake measurement data represents at least one stake characteristic selected from a group consisting of statistical distribution of a number of stakes formed, frequency of stakes formed, and depth of stakes formed.

33. The method of claim 17, wherein the stake measurement data represents at least a frequency of stakes formed, and further comprising controlling a duty cycle and frequency of the process beam in response to the frequency of stakes formed.

34. The method of claim 17, wherein at least the first workpiece material is a reflective metal and has a thickness less than 0.5 mm.

35. The method of claim 17, wherein the first and second workpiece materials are dissimilar metals.
